(19) United States
(12) Patent Application Publication
(10) Pub. No.: US 2014/0040827 A1
(43) Pub. Date: Feb. 6, 2014

(54) INFORMATION TERMINAL HAVING TOUCH SCREENS, CONTROL METHOD THEREFOR, AND STORAGE MEDIUM

(71) Applicant: CANON KABUSHIKI KAISHA, Tokyo (JP)

(72) Inventor: Yasushi Shinto, Inagi-shi (JP)

(73) Assignee: CANON KABUSHIKI KAISHA, Tokyo (JP)

(21) Appl. No.: 13/951,814

(22) Filed: Jul. 26, 2013

(30) Foreign Application Priority Data
Jul. 31, 2012 (JP) 2012-169591

(51) Int. Cl. G06F 3/0482; G06F 3/0485

(52) U.S. Cl. CPC G06F 3/0482; G06F 3/0485
USPC 715/835

(57) ABSTRACT

An information terminal which is capable of moving an image, which is displayed on a display, in an efficient and intuitive manner. The information terminal has a first touch screen combined with the display, and a second touch screen. Among a plurality of images displayed on the display, an image corresponding to a position touched by a user on the first touch screen is selected. When the user performs an operation for scrolling the plurality of images on the second touch screen, a plurality of other images other than the selected image among the plurality of images are scrolled.

### BACKGROUND OF THE INVENTION

1. Field of the Invention

The present invention relates to an information apparatus, a control method therefor, and a computer-readable storage medium storing a program for implementing the control method.

2. Description of the Related Art

Conventionally, image forming apparatuses for use in public spaces such as offices and convenience stores have a function of printing photo images taken by a camera function of a digital camera or a mobile terminal, document data downloaded from the Internet, and so on.

Such image forming apparatuses are equipped with a preview function of previewing read images and printing results, and a touch screen is often used for a display.

In recent years, touch screens have been used for mobile terminals as well, and mobile terminals typified by smartphones and tablet PCs have become more sophisticated by having substantially the same functions as PCs. Thus, operations performed by users have become similar to operations performed using PCs.

It is envisaged that in future, preview images are displayed on a mobile terminal and subjected to editing or the like.

In relation to touch screens of image forming apparatuses and mobile terminals described above, there has conventionally been known a technique that moves an image displayed on a display having a touch screen.

For example, there has been a method that, to move an image displayed on a display from a display range of the display, selects an image to be moved, holds the image at an end of the display, and scrolls images other than the selected image among images displayed on the display.

There has also been disclosed a technique that, with an image to be moved selected on a touch screen, further performs an operation on the touch screen to scroll images other than the selected image (see, for example, Japanese Laid-Open Patent Publication (Kokai) No. 2012-48525).

However, according to the method that holds a selected image at an end of a display to scroll images other than the selected image to desired positions, when the images other than the selected image are scrolled beyond desired positions, the images other than the selected image need to be scrolled in a direction opposite to a direction in which they have originally been scrolled.

It is thus necessary to move the selected image to an opposite end of the display and hold it again. This is inconvenient for a user.

Moreover, for touch screens, there are operations by multi-touch such as pinch-in and pinch-out, and in many cases, these operations are assigned to enlargement and reduction of images and the like.

According to the technique disclosed in Japanese Laid-Open Patent Publication (Kokai) No. 2012-48525), an operation performed after a selected state of a display image is detected is recognized as a moving instruction. Thus, in a moving mode in which a displayed image is moved, neither pinch-in nor pinch-out can be performed on the displayed image, and it is necessary to exit the moving mode.

Moreover, although a selected state of a display image is detected based on positional information on the selected image or information indicative of the selected image being at standstill, a difference between an operation performed in selecting an image and an operation by multi-touch such as pinch-in or pinch-out is not intuitive for a user, and this may lead to erroneous operation.

### SUMMARY OF THE INVENTION

The present invention provides an information terminal and a control method therefor which are capable of moving an image, which is displayed on a display, in an efficient and intuitive manner, as well as a computer-readable storage medium storing a program for implementing the control method.

Accordingly, a first aspect of the present invention provides an information terminal having a display, a first touch screen combined with the display, and a second touch screen, comprising a selection unit configured to select an image corresponding to a position touched by a user on the first touch screen among a plurality of images displayed on the display, and a scroll unit configured to, when the user performs an operation for scrolling the plurality of images on the second touch screen, scroll a plurality of other images other than the image selected by the selection unit among the plurality of images.

Accordingly, a second aspect of the present invention provides an information terminal having a display, a first touch screen combined with the display, and a second touch screen, comprising a selection unit configured to select an image corresponding to a position touched by a user on the second touch screen among a plurality of images displayed on the display, and a scroll unit configured to, when the user performs an operation for scrolling the plurality of images on the first touch screen, scroll a plurality of other images other than the image selected by the selection unit among the plurality of images.

Accordingly, a third aspect of the present invention provides a control method for an information terminal having a display, a first touch screen combined with the display, and a second touch screen, comprising a selection step of selecting an image corresponding to a position touched by a user on the first touch screen among a plurality of images displayed on the display, and a scroll step of, when the user performs an operation for scrolling the plurality of images on the second touch screen, scrolling a plurality of other images other than the image selected in the selection step among the plurality of images.

Accordingly, a fourth aspect of the present invention provides a control method for an information terminal having a display, a first touch screen combined with the display, and a second touch screen, comprising a selection step of selecting an image corresponding to a position touched by a user on the second touch screen among a plurality of images displayed on the display, and a scroll step of, when the user performs an operation for scrolling the plurality of images on the first touch screen, scrolling a plurality of other images other than the image selected in the selection step among the plurality of images.

Accordingly, a fifth aspect of the present invention provides a non-transitory computer-readable storage medium storing a program for causing a computer to implement a control method for an information terminal having a display, a first touch screen combined with the display, and a second touch screen, the control method comprising a selection step of selecting an image corresponding to a position touched by a user on the first touch screen among a plurality of images displayed on the display, and a scroll step of, when the user performs an operation for scrolling the plurality of images on the second touch screen, scrolling a plurality of other images other than the image selected in the selection step among the plurality of images.

Accordingly, a sixth aspect of the present invention provides a non-transitory computer-readable storage medium storing a program for causing a computer to implement a control method for an information terminal having a display, a first touch screen combined with the display, and a second touch screen, the control method comprising a selection step of selecting an image corresponding to a position touched by a user on the second touch screen among a plurality of images displayed on the display, and a scroll step of, when the user performs an operation for scrolling the plurality of images on the first touch screen, scrolling a plurality of other images other than the image selected in the selection step among the plurality of images.

According to the present invention, an image displayed on a display can be moved in an efficient and intuitive manner.

Further features of the present invention will become apparent from the following description of exemplary embodiments (with reference to the attached drawings).

### BRIEF DESCRIPTION OF THE DRAWINGS

FIGS. 1A and 1B are views showing an appearance of an information terminal according to an embodiment of the present invention, in which FIG. 1A shows a front side appearance of the information terminal, and FIG. 1B shows a rear side appearance of the information terminal.

FIG. 2 is a diagram schematically showing arrangements of the information terminal appearing in FIG. 1 and an image processing apparatus.

FIGS. 3A to 3F are views useful in explaining exemplary operations on preview images according to the present embodiment on a first touch screen and a second touch screen appearing in FIG. 1.

FIG. 4 is a flowchart showing the procedure of a moving process carried out by a CPU of an operation control unit appearing in FIG. 2.

FIGS. 5A to 5F are views useful in explaining exemplary operations on icons according to the present embodiment on the first touch screen and the second touch screen appearing in FIG. 1.

### DESCRIPTION OF THE EMBODIMENTS

The present invention will now be described in detail with reference to the drawings showing an embodiment thereof.

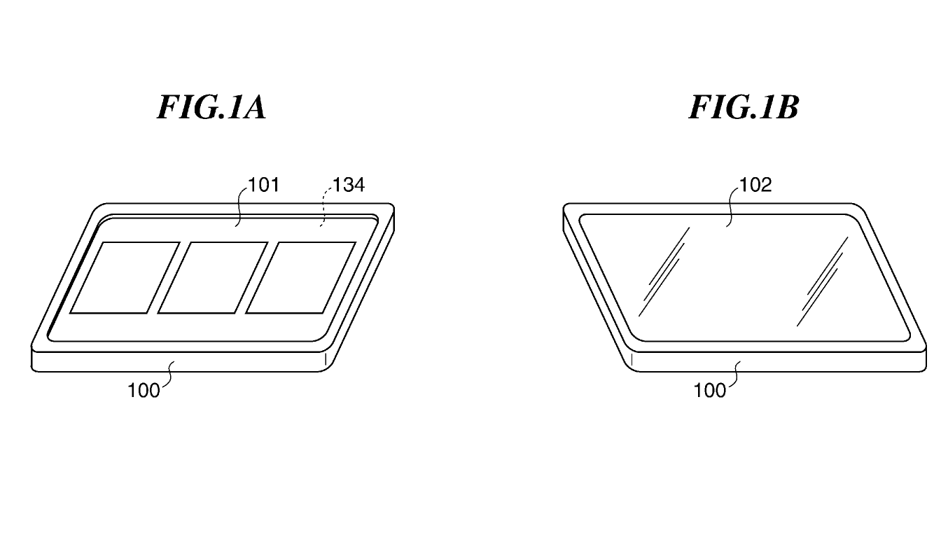

FIGS. 1A and 1B are views showing an appearance of an information terminal 100 according to an embodiment of the present invention, in which FIG. 1A shows a front side appearance of the information terminal 100, and FIG. 1B shows a rear side appearance of the information terminal 100.

The information terminal 100 has a touch screen 101 on a front side which is one surface of the information terminal 100 as shown in FIG. 1A, and has a touch screen 102 on a rear side which is the other surface of the information terminal 100 as shown in FIG. 1B.

The touch screen 101 is combined with a liquid crystal display 134, which is a display provided under the touch screen 101, to have a double-layer structure. Thus, the information terminal 100 has touch screens on both sides.

It should be noted that an image displayed on the liquid crystal display 134 is usually selected by a user touching the touch screen 101, but may be selected by the user touching the touch screen 102. The touch screen 101 and the touch screen 102 act as respective sensors that detect positions touched by user's fingers.

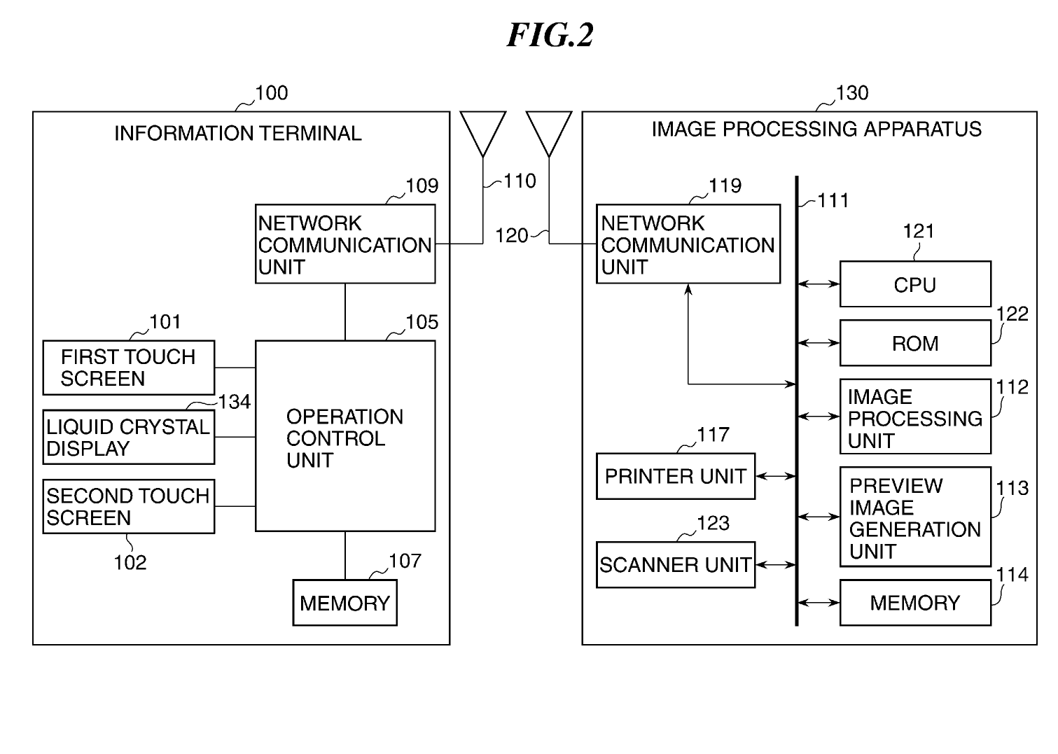

FIG. 2 is a diagram schematically showing arrangements of the information terminal 100 appearing in FIG. 1 and an image processing apparatus 130.

Referring to FIG. 2, the information terminal 100 is used mainly in performing operations on the image processing apparatus 130 such as displaying preview images generated by the image processing apparatus 130, and as shown in the figure, the information terminal 100 and the image processing apparatus 130 are configured as separate units.

The image processing apparatus 130 is a printer, a copier, a scanner, a facsimile, or the like, but may be one which has no printer unit or scanner unit.

The information terminal 100 should not always be designed specially for the image processing apparatus 130, but may be installed with an application for displaying preview images, which are generated by the image processing apparatus 130, on a general tablet terminal. The information terminal 100 can be either a mobile terminal or a personal computer as long as it has the touch screen 101 and the touch screen 102.

The information terminal 100 has an operation control unit 105, the first touch screen 101, the liquid crystal display 134, the second touch screen 102, a memory 107, a network communication unit 109, and an antenna 110.

The operation control unit 105 has a CPU, a ROM, in which programs for controlling the information terminal 100 are stored, and so on, and the CPU controls the information terminal 100 in accordance with the programs stored in the ROM.

In the memory 107, for example, coordinates of positions touched on the first touch screen 101 and the second touch screen 102 and other information are stored.

The user can perform operations on the first touch screen 101 and the second touch screen 102 independently of each other.

Processes such as selection of an operation mode, setting of various functions, operating instruction, and selection and movement of image data during edition of the image data can be assigned to operations on the first touch screen 101 and the second touch screen 102.

Moreover, when image data is being displayed on the first touch screen 101, the user can perform screen operations such as touching, dragging, pinching, and flicking on displayed images. Further, processes such as a process to specify positional information on desired coordinates of an image can be assigned to a certain operation.

Details of operations thus performed by the user are successively sent to the operation control unit 105 from the first touch screen 101 and the second touch screen 102.

The network communication unit 109 carries out communications with other devices via the antenna 110 using, for example, a WLAN communication system, and in the present embodiment, is particularly used for communications with the image processing apparatus 130. Thus, the image processing apparatus 130 is capable of carrying out communications with the information terminal 100.

Data from the image processing apparatus 130 to the information terminal 100 such as image data, print data, and menu display for issuing operational instructions, and data from the information terminal 100 to the image processing apparatus 130 such as a command that requests printing are communicated between the information terminal 100 and the image processing apparatus 130.

The information terminal 100 may include hardware such as a camera, a hardware button, and a USB terminal, and so on which general tablet terminals, smartphones, and so on have.

The image processing apparatus 130 has a CPU 121, a ROM 122, an image processing unit 112, a preview image generation unit 113, a memory 114, a printer unit 117, a scanner unit 123, a network communication unit 119, and an antenna 120, which are connected together via a bus 111.

The CPU 121 controls the image processing apparatus 130 in accordance with programs stored in the ROM 122. The ROM 122 is a nonvolatile storage device such as flash memory, in which various information as well as the programs described above are stored.

The memory 114 is used as a storage area for image data and a work area for the CPU 121.

The image processing unit 112 carries out predetermined processing determined in advance on image data. For example, the image processing unit 112 performs image processing on image data in accordance with print settings from the information terminal 100. Image data that has been subjected to image processing by the image processing unit 112 is stored in the memory 114.

The preview image generation unit 113 reads image data, which has been subjected to image processing and stored in the memory 114, and generates preview images to be displayed on the first touch screen 101.

The printer unit 117 reads image data that has been subjected to image processing and stored in the memory 114, and if, for example, the printer is based on an electrophotographic method, generates laser pulses for forming a latent image on a photosensitive image carrier through PWM modulation in accordance with the image data. The image formed on the photosensitive image carrier is transferred to and then fixed on a sheet and output from the image processing apparatus 130.

The scanner unit 123 reads an original using a read sensor, digitalizes image data, and stores the image data in the memory 114.

For example, when the information terminal 100 requests a scanning process, an original is read by as scan data by the read sensor. The read scan data is converted into digital data by the scanner unit 123 and then stored as image data in the memory 114.

The image data stored in the memory 114 is subjected to various types of image processing by the image processing unit 112, and preview images are generated through those various types of image processing. The generated preview images are stored in the memory 114. When the preview images are to be displayed on the information terminal 100, the preview images are transmitted to the information terminal 100.

It should be noted that the CPU 121, the network communication unit 119, the image processing unit 112, the preview image generation unit 113, the printer unit 117, and the scanner unit 123 can be bus masters on the bus 111.

With the arrangement described above, the user can view preview images using the information terminal 100. The information terminal 100 is capable of editing preview images, and sends the image processing apparatus 130 an instruction to print image data, which is obtained by shooting using a camera if the information terminal 100 has the camera, document file data obtained by downloading, and so on. The image processing apparatus 130 which has received the print instruction from the information terminal 100 carries out printing.

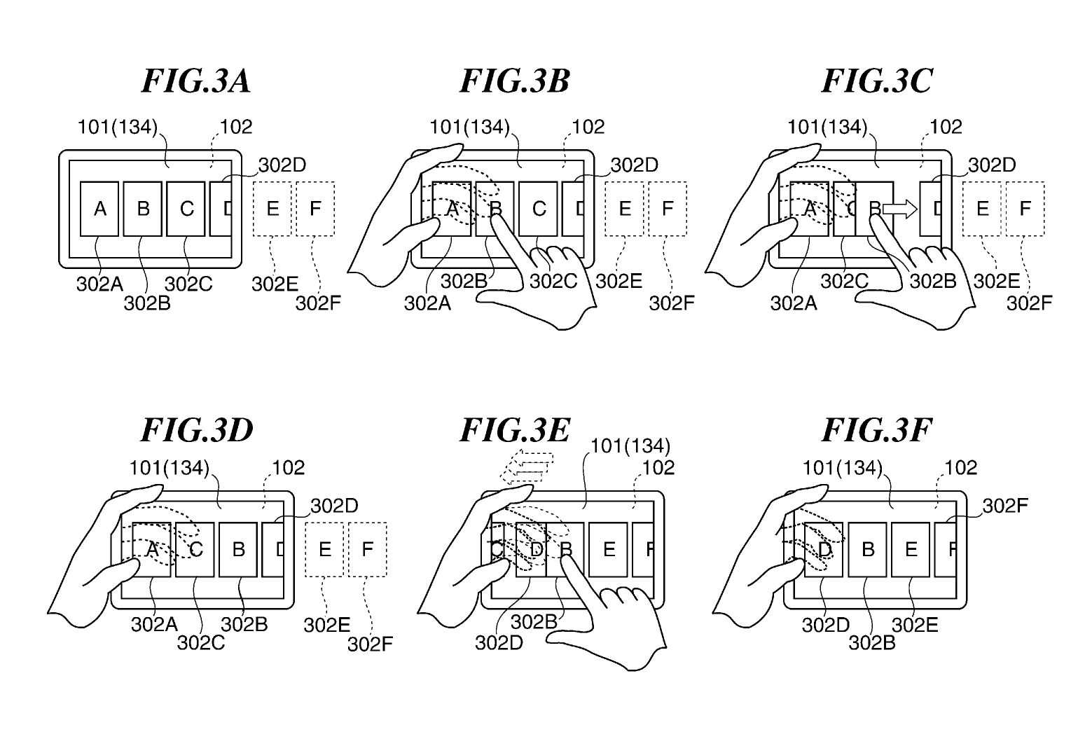

FIGS. 3A to 3F are views useful in explaining exemplary operations on preview images according to the present embodiment on the first touch screen 101 and the second touch screen 102 appearing in FIG. 1.

In examples shown in FIGS. 3A to 3F, six preview images arranged sideways are displayed.

Referring first to FIG. 3A, preview images 302A to 302D are displayed. A description will now be given of an operation performed in a case where, in this state, the preview image 302B is moved and put between the preview image 302C and the preview image 302D.

First, as shown in FIG. 3B, the user touches a position corresponding to the preview image 302B on the first touch screen 101 of the information terminal 100.

Next, the user moves the finger touching the first touch screen 101 of the information terminal 100 from left to right as indicated by an arrow in FIG. 3C and moves (drags) the preview image 302B to put it between the preview image 302C and the preview image 302D. It should be noted that a dragging operation means an operation in which, with a preview image selected by a finger touching the first touch screen 101, the finger touching the first touch screen 101 is moved on a screen.

The user then releases the finger touching the first touch screen 101 as shown in FIG. 3D to confirm the position to which the preview image 302B has been moved.

A description will now be given of a case where the preview image 302B is further moved and put between the preview image 302D and a preview image 302E, which is not displayed on the liquid crystal display 134.

The user touches a position corresponding to the preview image 302B on the first touch screen 101, and as shown in FIG. 3E, at the same time when touching the first touch screen 101, moves fingers touching the second touch screen 102 from right to left as indicated by dashed arrows in the figure.

As a result, the preview images 302A and 302C to 302F other then the preview image 302B are scrolled.

Then, as shown in FIG. 3F, the user moves the preview image 302B to put it between the preview image 302D and the preview image 302E, and then releases the finger touching the first touch screen 101. Thus, the user can move the preview image 302B to put it between the preview image 302D and the preview image 302E.

As described above, according to the present embodiment, the user operates the first touch screen 101 on the front side to select a preview image to be moved, and operates the second touch screen 102 on the rear side to move preview images other than the selected preview image. Thus, the user can move a preview image, which is displayed on the display, in an intuitive and easy-to-understand way with no limits on operations performed in the case of multi-touch on the front side.

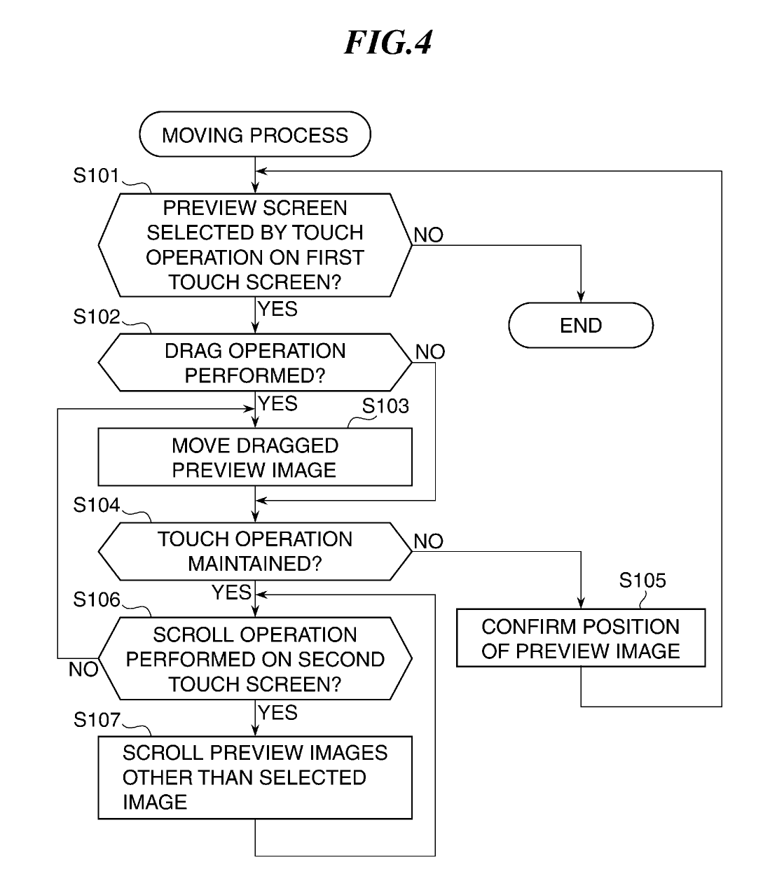

FIG. 4 is a flowchart showing the procedure of a moving process carried out by a CPU of the operation control unit 105 appearing in FIG. 2.

Referring to FIG. 4, whether or not any preview image has been selected by a touch operation on the first touch screen 101 is determined on, for example, a preview screen appearing in FIG. 3E displayed on the liquid crystal display 134 (step S101).

When, as a result of the determination in the step S101, no preview image has been selected by a touch operation on the first touch screen 101 (NO in the step S101), the present process is terminated.

On the other hand, when, as a result of the determination in the step S101, a preview image has been selected by a touch operation on the first touch screen 101 (YES in the step S101), it is determined whether or not a drag operation has been performed on the selected preview image (step S102). This step S101 corresponds to a selection unit configured to select an image corresponding to a position touched by the user on either one of the first touch screen 101 and the second touch screen 102. In the case of this flowchart, one touch screen is the first touch screen 101, and an image corresponding to a position touched by the user on the first touch screen 101 is selected.

When, as a result of the determination in the step S102, no drag operation has been performed on the selected preview image (NO in the step S102), the process proceeds to step S104.

On the other hand, when, as a result of the determination in the step S102, a drag operation has been performed on the selected preview image (YES in the step S102), the preview image is moved (step S103).

Then, it is determined whether or not the touch operation on the first touch screen 101 on which the preview image is selected is maintained (step S104).

When, as a result of the determination in the step S104, the touch operation on the first touch screen 101 is not maintained (NO in the step S104), the position of the preview image is confirmed (step S105), and the process returns to the step S101.

On the other hand, when, as a result of the determination in the step S104, the touch operation on the first touch screen 101 is maintained (YES in the step S104), it is determined whether or not a scroll operation by flicking or the like on the second touch screen 102 has been performed (step S106).

When, as a result of the determination in the step S106, no scroll operation has been performed (NO in the step S106), the process returns to the step S103.

On the other hand, when, as a result of the determination in the step S106, a scroll operation has been performed (YES in the step S106), a process described hereafter is carried out. The operation control unit 105 scrolls preview images other than the image selected on the first touch screen 101 according to a moving direction and speed of the scroll operation on the second touch screen 102 (step S107), and returns to the step S106. This step S106 corresponds to a scroll unit configured to scroll a plurality of images other than a selected image when the user performs an operation for scrolling a screen on the other touch screen. In the case of this flowchart, the other touch screen is the second touch screen 102.

Also, in the step S106, as described above, the operation control unit 105 determines a speed at which a plurality of images other than an image selected by the user are to be scrolled.

According to the moving process in FIG. 4, an image corresponding to a position touched by the user on either one of the first touch screen 101 and the second touch screen 102 is selected among a plurality of images displayed on a screen. Then, when the user performs an operation for scrolling the screen on the other touch screen, a plurality of images other than the selected image are scrolled. Thus, the user can move a preview image in an intuitive manner.

It should be noted that in the moving process in FIG. 4, in response to a scroll operation on the second touch screen 102, preview images other than a selected preview image are moved, but this may be reversed. Specifically, it may be arranged such that when the user selects a preview image on the second touch screen 102 and performs a scroll operation on the first touch screen 101, preview images other than the selected preview image are moved.

Referring to FIG. 4, it has been described that the user performs a touch operation on the first touch screen 101 and performs a scroll operation on the second touch screen 102. On the other hand, when the user performs a scroll operation on the second touch screen 102 without performing a touch operation on the first touch screen 101, all preview images displayed on the liquid crystal display 134 are scrolled.

The moving process described above with reference to FIG. 4 targets at preview images, but may target at icons in place of preview images.

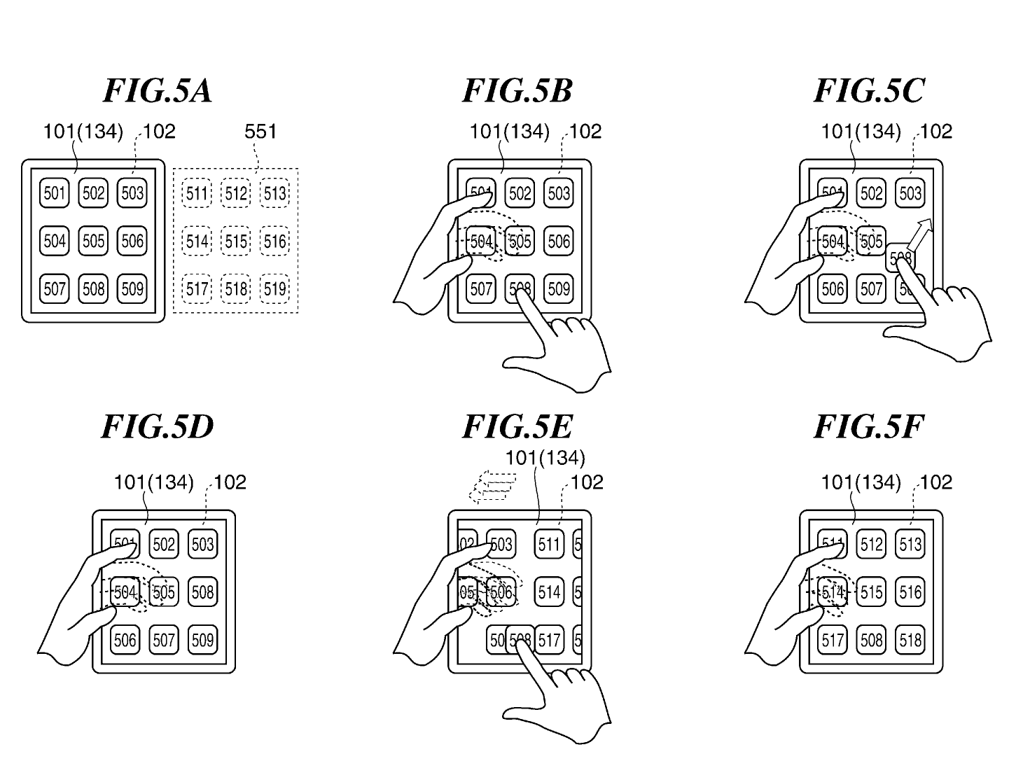

FIGS. 5A to 5F are views useful in explaining exemplary operations on icons according to the present embodiment on the first touch screen 101 and the second touch screen 102 appearing in FIG. 1.

In examples shown FIGS. 5A to 5F, nine icons arranged in a grid pattern are displayed, and a screen 551 appearing in FIG. 5A represents a screen on a next page that follows a currently-displayed screen.

Referring first to FIG. 5A, icons 501 to 509 are displayed on the liquid crystal display 134. A description will now be given of an operation performed in a case where, at this time, the user moves the icon 508 to the position of the icon 506.

On the first touch screen 101 of the information terminal 100, the user touches a position corresponding to the icon 508 as shown in FIG. 5B.

The user then moves a finger touching the first touch screen 101 of the information terminal 100 to move (drag) the icon 508 to the position of the icon 506 as shown in FIG. 5C.

The user then releases the finger touching the first touch screen 101 to confirm the position to which the icon 508 has been moved.

Next, a description will be given of an operation performed in a case where the icon 508 appearing in FIG. 5B is moved to the position of an icon 518 which is not displayed on the currently-displayed screen of the liquid crystal display 134.

As shown in FIG. 5E, at the same time when performing a touch operation on the first touch screen 101, the user scrolls fingers touching the second touch screen 102 from right to left as indicated by dashed arrows in the figure. As a result, the icons 501 to 507 and 509 other than the icon 508 move from right to left.

The user then touches a position corresponding to the icon 508 on the first touch screen 101, and as shown in FIG. 5F, moves the icon 508 to the position at which the icon 518 was present on the screen 551, and then releases the finger touching the first touch screen 101. As a result, the user can move the icon 508 to the position of the icon 518.

As described above, similarly to the description referring to FIGS. 3A to 3F, according to the present embodiment, the user can select a preview image to be moved on the first touch screen 101 on the front side and move preview images other than the selected preview image on the second touch screen 102 on the rear side. Thus, the user can move a preview image in an intuitive and easy-to-understand manner with no limits on multi-touch operations on the front side.

Moreover, as described above, although in the exemplary operations appearing in FIGS. 5A to 5F, when a scroll operation is performed on the second touch screen 102, icons other than an icon selected on the first touch screen 101 are moved by scrolling, the operations on the first touch screen 101 and the second touch screen 102 may be reversed. Specifically, when the user selects an icon on the second touch screen 102 and performs a scroll operation on the first touch screen 101, icons other than the selected icon may be moved.

Further, because as described above with reference to FIGS. 1A and 1B, the information terminal 100 is not limited to one specialized for the image processing apparatus 130, the exemplary operations shown in FIGS. 5A to 5F may also be applied to movement of icons displayed on screens of general tablet terminals, smartphones, and PCs.

According to the present embodiment, any image among a plurality of images displayed on the display is selected on one touch screen, and a plurality of images other than the image selected on one touch screen are scrolled by operating the other touch screen.

As a result, selection of an image to be moved and scrolling of images other than the selected image can be done at the same time and independently of each other. This enables the user to move an image in an intuitive, easy-to-understand, and efficient manner, and also, convenience for the user can be enhanced.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-169591 filed Jul. 31, 2012, which is hereby incorporated by reference herein in its entirety.

What is claimed is:

1. An information terminal having a display, a first touch screen combined with the display, and a second touch screen, comprising:
a selection unit configured to select an image corresponding to a position touched by a user on the first touch screen among a plurality of images displayed on the display; and
a scroll unit configured to, when the user performs an operation for scrolling the plurality of images on the second touch screen, scroll a plurality of other images other than the image selected by said selection unit among the plurality of images.

2. The information terminal according to claim 1, wherein:
the information terminal is capable of carrying out communications with an image processing apparatus, and
the plurality of images are preview images or icons of images that are processed by the image processing apparatus.

3. The information terminal according to claim 1, wherein according to the operation performed by the user, said scroll unit determines a speed at which the plurality of other images other than the image selected by said selection unit are to be scrolled.

4. The information terminal according to claim 1, wherein, when no image is selected by said selection unit, said scroll unit scrolls the plurality of images.

5. An information terminal having a display, a first touch screen combined with the display, and a second touch screen, comprising:
a selection unit configured to select an image corresponding to a position touched by a user on the second touch screen among a plurality of images displayed on the display; and
a scroll unit configured to, when the user performs an operation for scrolling the plurality of images on the first touch screen, scroll a plurality of other images other than the image selected by said selection unit among the plurality of images.

6. The information terminal according to claim 5, wherein:
the information terminal is capable of carrying out communications with an image processing apparatus, and
the plurality of images are preview images or icons of images that are processed by the image processing apparatus.

7. The information terminal according to claim 5, wherein according to the operation performed by the user, said scroll unit determines a speed at which the plurality of other images other than the image selected by said selection unit are to be scrolled.

8. The information terminal according to claim 5, wherein, when no image is selected by said selection unit, said scroll unit scrolls the plurality of images.

9. A control method for an information terminal having a display, a first touch screen combined with the display, and a second touch screen, comprising:
a selection step of selecting an image corresponding to a position touched by a user on the first touch screen among a plurality of images displayed on the display; and
a scroll step of, when the user performs an operation for scrolling the plurality of images on the second touch screen, scrolling a plurality of other images other than the image selected in said selection step among the plurality of images.

10. A control method for an information terminal having a display, a first touch screen combined with the display, and a second touch screen, comprising:
a selection step of selecting an image corresponding to a position touched by a user on the second touch screen among a plurality of images displayed on the display; and
a scroll step of, when the user performs an operation for scrolling the plurality of images on the first touch screen, scrolling a plurality of other images other than the image selected in said selection step among the plurality of images.

11. A non-transitory computer-readable storage medium storing a program for causing a computer to implement a control method for an information terminal having a display, a first touch screen combined with the display, and a second touch screen, the control method comprising:
a selection step of selecting an image corresponding to a position touched by a user on the first touch screen among a plurality of images displayed on the display; and
a scroll step of, when the user performs an operation for scrolling the plurality of images on the second touch screen, scrolling a plurality of other images other than the image selected in the selection step among the plurality of images.

12. A non-transitory computer-readable storage medium storing a program for causing a computer to implement a control method for an information terminal having a display, a first touch screen combined with the display, and a second touch screen, the control method comprising:
a selection step of selecting an image corresponding to a position touched by a user on the second touch screen among a plurality of images displayed on the display; and
a scroll step of, when the user performs an operation for scrolling the plurality of images on the first touch screen, scrolling a plurality of other images other than the image selected in the selection step among the plurality of images.
